(19) United States
(12) Patent Application Publication
(10) Pub. No.: US 2016/0308432 A1
(43) Pub. Date: Oct. 20, 2016

(54) POWER CIRCUIT WITH LOW TOTAL HARMONIC DISTORTION

(71) Applicant: ANWELL SEMICONDUCTOR CORP., HSIN-CHU CITY (TW)

(72) Inventors: KE-HORNG CHEN, HSINCHU CITY (TW); SHAO-WEI CHIU, HSIN-CHU CITY (TW); CHUN-CHIEH KUO, HSIN-CHU CITY (TW); SHIH-PING TU, HSIN-CHU CITY (TW); CHENG-PO HSIAO, HSIN-CHU CITY (TW)

(21) Appl. No.: 14/686,941

(22) Filed: Apr. 15, 2015

(51) Int. Cl. H02M 1/12; H02M 7/06

(52) U.S. Cl. CPC H02M 1/12; H02M 7/06

(57) ABSTRACT

A power circuit with a low total harmonic distortion includes a conversion module and a control module, and the conversion module includes a first switch, a second switch, a power storage element and a conversion element. Both ends of the power storage element are electrically connected to the first switch, the second switch and the conversion element. Trigger ends of the first and second switches are electrically connected to the control module. If the input voltage is smaller than a predetermined value, the control module will output a control pulse to the second switch, and the second switch will conduct and drive the power storage element to boost the input voltage to generate a compensating current in a timing cycle, and the second switch will cut off and allow the compensating current to be converted into a voltage form by the conversion element and outputted in another timing cycle.

### BACKGROUND OF THE INVENTION

1. Field of the Invention

The present invention relates to the field of power supply equipments, and more particularly to a power circuit with a low total harmonic distortion (THD) that will start a current compensation to reduce the THD value of the overall circuit if the input voltage of the circuit is smaller than a predetermined value.

2. Description of the Related Art

In general, a power supply provided for driving the operation of various electronic devices converts AC voltage and power of the mains power to generate a driving voltage or current required by an electronic device. To output a stable voltage or current, the power supply generally adopts the Pulse Width Modulation (PWM) control method to control the output voltage or current value. In various different power supplies, the switching power supply (SPS) with the features of high efficiency, small volume, light weight, easy assembling and large scope of output voltage is used extensively in electronic devices such as liquid crystal display (LCD), television (TV) or light emitting diode (LED) lamps, and the common ones are boost, buck, fly-back, forward and push-pull circuits. Wherein, the boost power circuit with the advantages of low input current and low output voltage is commonly used as the circuit architecture for PFC Power Factor Correction (PFC) devices, but practical applications require higher voltage resisting components for the Pulse Width Modulation (PWM) control circuit and incur a high cost of the overall circuit, when the input voltage is 90V-260V and the output voltage is 400V-450V.

Although the buck power circuit does not have the aforementioned problem, yet the input current is not continuous, and thus the waveform of the input current is distorted significantly and contains higher harmonic waves of the output current. At present, the circuit of an electronic device is generally designed according to the harmonic wave standards of the countries or districts where the electronic device is sold. For example, a lamp sold to European Union or European Free Trade Area follows the EN61347 standard and the EN61000-3-2 current harmonic quality standard. An input power greater than 25 W should comply with the Class C requirement and an input power smaller than 25 W should comply with the Class D requirement. At present, the EN61347 standard has not specified the THD, but the Taiwan National Standard CNS15233 requires a THD smaller than 33%, and the U.S. Energy Star Standard ANSI_C82-77-2002 requires a THD smaller than 32%, and some special product requires a THD of 20%. As to the sinusoidal change of the input current, the output current, voltage, power, and THD are changed accordingly. The greater the output power, the higher level of difficulty to control the THD within a stable range. Therefore, the product quality is unstable and such product cannot be introduced into some markets, and the industrial and economic values of the product are reduced. If a safety component is added to stabilize the THD, the cost of the lamp will be increased, and the higher cost is disadvantageous to the sales competition.

In addition, the Buck-Boost architecture may be able to overcome the aforementioned problem, but there will be an efficiency loss as the sine wave of the input voltage drops, since the duty cycle ratio of the two power switches installed in the conventional circuit is close to the critical conditions of a full open circuit (with a duty cycle of 100%). Furthermore, the input current and the output current are discontinuous and have the issues of electromagnetic interference and high output noises.

In view of the aforementioned problems, it is a main subject of the present invention to control the THD within a range in compliance with the EN61000-3-2, CNS15233 and ANSI_C82-77-2002 standards without requiring the installation of additional safety components, but simply using a simple and low-cost circuit architecture to implement the power factor correction (PFC) and stabilize the working quality of the whole circuit.

### SUMMARY OF THE INVENTION

Therefore, it is a primary objective of the present invention to provide a power circuit with a low total harmonic distortion, wherein a control chip is used to control the operation of two switches installed at the front and rear of a power storage element respectively, so that the power storage element is capable of providing a compensating current to reduce the high THD value continuously produced by the output current.

To achieve the aforementioned objective, the present invention provides a power circuit with a low total harmonic distortion, and the power circuit comprises a rectification module, a conversion module and a control module, wherein the rectification module is electrically coupled to an external power supply and the conversion module for rectifying the current of an AC voltage of the external power supply to generate an input voltage to the conversion module, and the conversion module is electrically coupled to at least one load and the control module for converting the input voltage into an output voltage and then outputting the output voltage to the load, characterized in that the conversion module includes a first switch, a second switch, a power storage element and a conversion element, and the first switch is electrically coupled to the rectification module, an end of the power storage element, and the control module, and the other end of the power storage element is electrically coupled to the second switch and the conversion element, and a trigger end of the second switch is electrically coupled to the control module; and if the input voltage is smaller than a predetermined value, the control module will output a control pulse to the second switch, so that the second switch conducts and drives the power storage element to boost the input voltage to generate a compensating current in a timing cycle, and the second switch cuts off and allows the compensating current to be converted into a voltage form and outputted by the conversion element in another timing cycle.

Wherein, the control module outputs a working pulse to the first switch to control a working status of the first switch, and if the input voltage is greater than the predetermined value, the control module will cut off the second switch and allow the input voltage to be stored by the power storage element to generate the output voltage and then output the output voltage to the load directly.

In addition, the control pulse has a duty cycle smaller than the duty cycle of the working pulse, and if the input voltage is smaller than the predetermined value, the conversion module will enter into a first timing cycle for conducting the first switch and cutting off the second switch, and then will enter into a second timing cycle for conducting the first switch and conducting the second switch, so that the power storage element stores the power of the input voltage to generate the compensating current; and then the conversion module will enter into a third timing cycle for conducting the first switch and cutting off the second switch, and then will enter into a fourth timing cycle for cutting off the first switch and cutting off the second switch, so that the compensating current is outputted through the conversion element.

In addition, the power storage element is an inductor, and the conversion element is a capacitor.

In summation of the description above, the present invention switches the working status of the first switch and the second switch in order to switch the whole circuit among three types of working modes, which are power conversion modes of the Buck, Boost and Buck-Boost circuit architectures. If the input voltage is smaller than the minimum forward bias required by the operation of the load, the power storage element will convert the electric power of the Boost power conversion mode into the compensating current, and thus the power circuit of the present invention has features of low cost, high power and low total harmonic distortion (THD).

### BRIEF DESCRIPTION OF THE DRAWINGS

FIG. 1 is a block diagram of a preferred embodiment of the present invention;

FIG. 2 is a waveform chart of a preferred embodiment of the present invention;

FIG. 3 is a circuit diagram of an implementation mode of a preferred embodiment of the present invention;

FIG. 4 is a timing diagram of PWM1 and PWM2 of an implementation mode of a preferred embodiment of the present invention;

FIG. 5 is an equivalent circuit diagram of the timing T0 of an implementation mode of a preferred embodiment of the present invention;

FIG. 6 is an equivalent circuit diagram of the timing T1 of an implementation mode of a preferred embodiment of the present invention;

FIG. 7 is an equivalent circuit diagram of the timing T2 of an implementation mode of a preferred embodiment of the present invention;

FIG. 8 is an equivalent circuit diagram of the timing T3 of an implementation mode of a preferred embodiment of the present invention;

FIG. 9 is an equivalent circuit diagram of the timing T4 of an implementation mode of a preferred embodiment of the present invention;

FIG. 10 is an equivalent circuit diagram of the timing T5 of an implementation mode of a preferred embodiment of the present invention;

FIG. 11 is a circuit diagram of another implementation mode of a preferred embodiment of the present invention; and

FIG. 12 is a timing diagram of PWM1 and PWM2 of another implementation mode of a preferred embodiment of the present invention.

### DETAILED DESCRIPTION OF THE PREFERRED EMBODIMENTS

The technical content of the present invention will become apparent with the detailed description of preferred embodiments and the illustration of related drawings as follows.

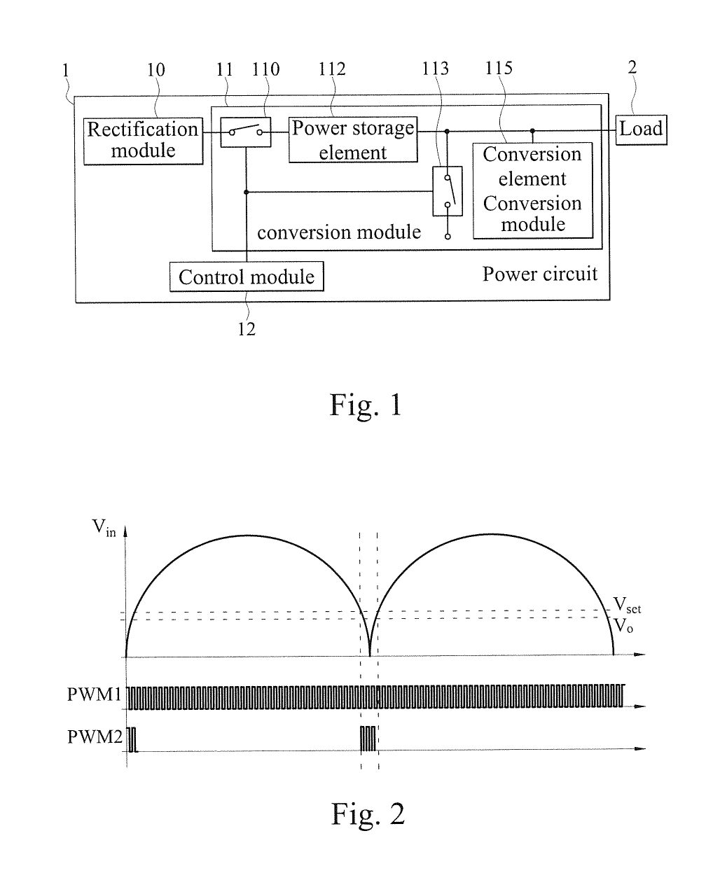

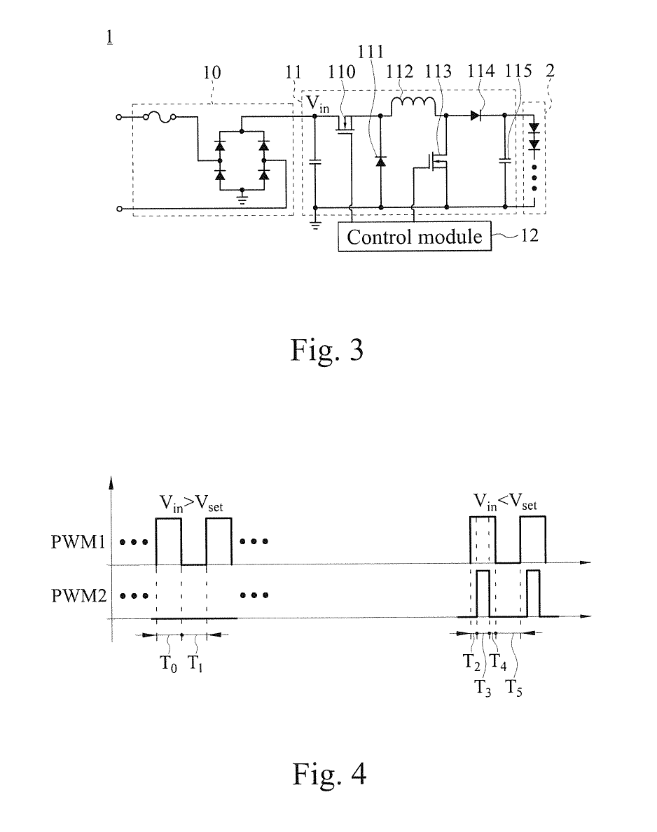

With reference to FIGS. 1-3 for a block diagram, a waveform chart and a circuit diagram of a power circuit with a low total harmonic distortion 1 in accordance with an implementation mode of a preferred embodiment of the present invention respectively, the power circuit with a low total harmonic distortion 1 comprises a rectification module 10, a conversion module 11 and a control module 12, wherein the rectification module 10 is electrically coupled to an external power supply (not shown in the figure) and the conversion module 11, and the conversion module 11 is electrically coupled to at least one load 2 and the control module 12. The rectification module 10 is a bridge rectifier for rectifying the current of an AC voltage of the external power supply to form an input voltage (Vin) and then supplying the input voltage (Vin) to the conversion module 11, and the conversion module 11 converts the input voltage into an output voltage (Vo) and outputs it to the load 2, and the conversion module 11 includes a first switch 110, a first diode 111, a power storage element 112, a second switch 113, a second diode 114 and a conversion element 115. The first switch 110 and the second switch 113 are metal oxide semiconductor field effect transistors (MOSFET), and the power storage element 112 is an inductor, and the conversion element 115 is a capacitor, and the first switch 110 has a drain coupled to an output end of the bridge rectifier, a gate coupled to the control module 12, and a source coupled to an end of the inductor and a cathode of the first diode 111. The other end of the inductor is coupled to a drain of the second switch 113 and an anode of the second diode 114, and the gate of the second switch 113 is coupled to the control module 12, and the cathode of the second diode 114 is coupled to the capacitor and the load 2.

The control module 12 outputs a working pulse (PWM1) to the first switch to control the working status of the first switch 110. If the input voltage is greater than a predetermined value, the control module 12 will cut off the second switch 113 and the power of the input voltage is stored by the power storage element 112 to form the output voltage and output the output voltage to the load 2 directly. If the input voltage is smaller than a predetermined value (Vset), the control module 12 will output a control pulse (PWM2) to the second switch 113, so that the second switch 113 conducts and drives the power storage element 112 to boost the input voltage to generate a compensating current in a timing cycle, and the second switch 113 cuts off and allows the compensating current to be converted into a form of voltage by the conversion element 115 and outputted in another timing cycle.

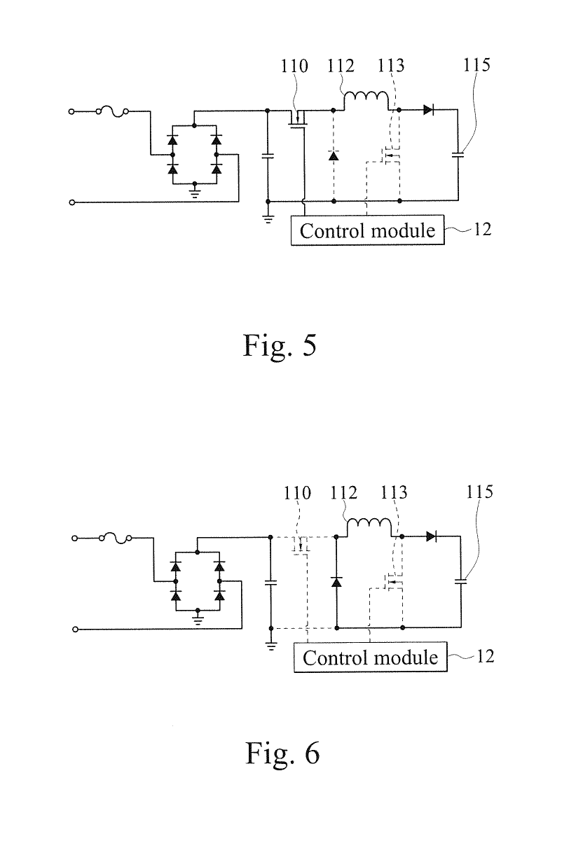

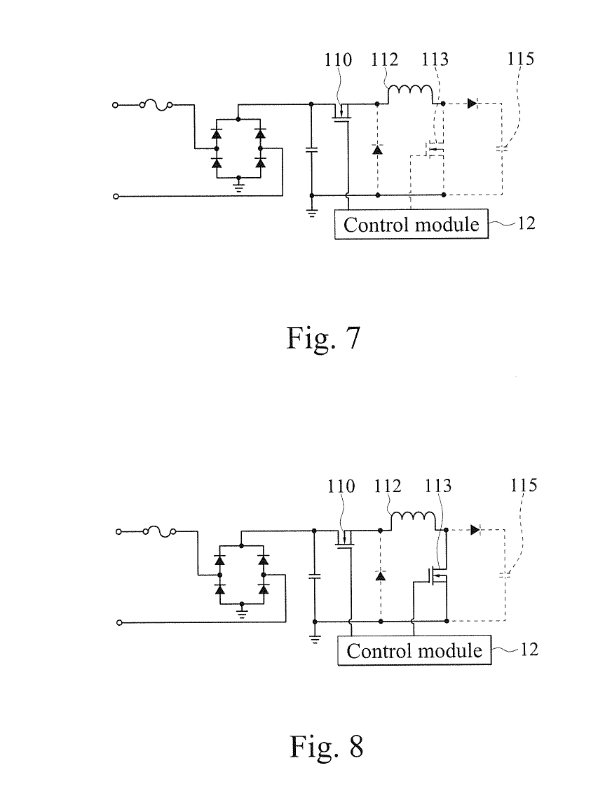

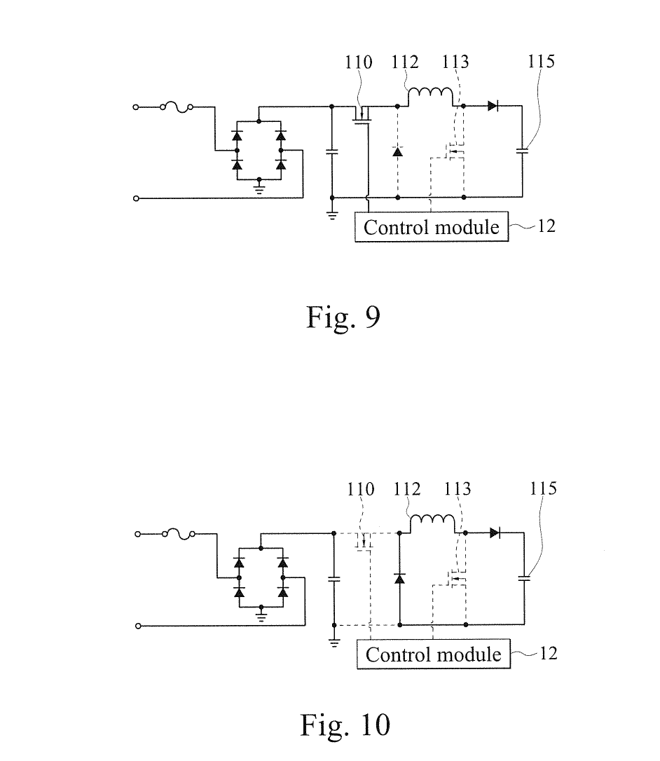

In a preferred embodiment, if the duty cycle of the control pulse as shown in FIG. 4 is smaller than the duty cycle of the working pulse, and the second switch 113 at a cutoff status has an input voltage greater than the predetermined value, the first switch 110 will be conducted and cut off according to the working pulse to enter the power circuit 1 into the timing cycles T0, T1 as shown in FIGS. 5 and 6. The operation of the power circuit 1 is similar to the power conversion mode of the Buck circuit architecture, and Vo=D (Duty Cycle, or the duty cycle of the first switch 110)*Vin. If the input voltage is smaller than the predetermined value, the first switch 110 of the conversion module 11 will be conducted according to the working pulse, and then the second switch 113 will enter into a first timing cycle T2 (as shown in FIG. 7) and will be maintained at a cutoff at an instantaneous moment, and then the second switch 113 will enter into a second timing cycle T3 and will be maintained at a conduction status as shown in FIG. 8, so that the power storage element 112 stores power of the input voltage to generate the compensating current. In addition, the conversion module 11 will enter into a third timing cycle for conducting the first switch 110 and cutting off the second switch 113. After the timing cycle T4 as shown in FIG. 9, the conversion module 11 will enter into a fourth timing cycle for cutting off the first switch 110 and cutting off the second switch 113. In the timing cycle T5 as shown in FIG. 10, the compensating current is outputted through the capacitor to compensate the total output voltage outputted from the power circuit 1 to the load 2.

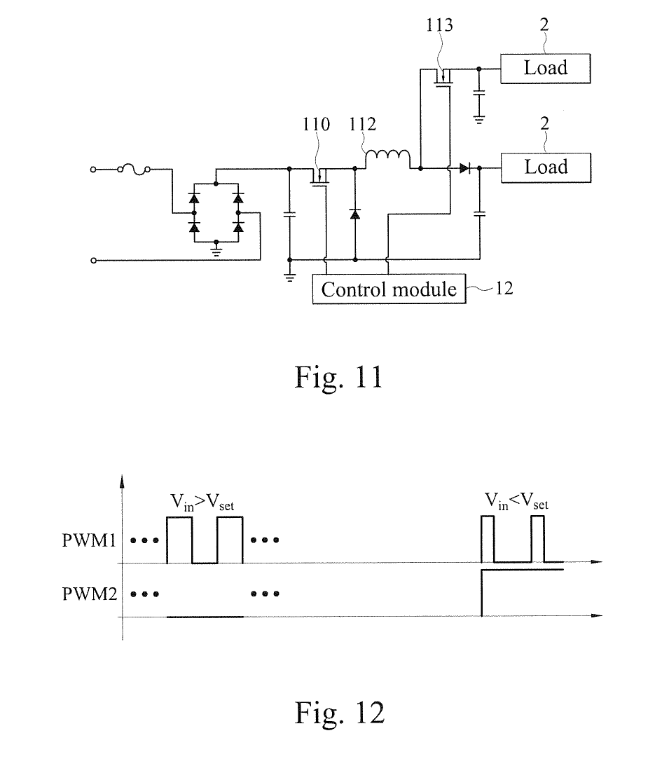

It is noteworthy that the power circuit 1 may be electrically coupled to a plurality of loads 2 as shown in FIGS. 11 and 12, and the compensating current is provided for compensating the original output voltage and solely serving as an independent power supply for supplying electric power to other loads 2.

What is claimed is:

1. A power circuit with a low total harmonic distortion, comprising a rectification module, a conversion module and a control module, and the rectification module being electrically coupled to an external power supply and the conversion module for rectifying the current of an AC voltage of the external power supply to generate an input voltage and supplying the input voltage to the conversion module, and the conversion module being electrically coupled to at least one load and the control module, for converting the input voltage into an output voltage and outputting the output voltage to the load, characterized in that the conversion module includes a first switch, a second switch, a power storage element and a conversion element, and the first switch is electrically coupled to the rectification module, an end of the power storage element, and the control module, and an another other end of the power storage element is electrically coupled to the second switch and the conversion element, and a trigger end of the second switch is electrically coupled to the control module; and if the input voltage is smaller than a predetermined value, the control module outputs a control pulse to the second switch, so that the second switch conducts and drives the power storage element to boost the input voltage to generate a compensating current in a timing cycle, and the second switch cuts off and allows the compensating current to be converted into a voltage form and outputted by the conversion element in another timing cycle.

2. The power circuit with a low total harmonic distortion as claimed in claim 1, wherein the control module outputs a working pulse to the first switch to control a working status of the first switch, and if the input voltage is greater than the predetermined value, the control module will cut off the second switch and allow the input voltage to be stored by the power storage element to generate the output voltage and then output the output voltage to the load directly.

3. The power circuit with a low total harmonic distortion as claimed in claim 2, wherein the control pulse has a duty cycle smaller than the duty cycle of the working pulse.

4. The power circuit with a low total harmonic distortion as claimed in claim 3, wherein if the input voltage is smaller than the predetermined value, the conversion module will enter into a first timing cycle for conducting the first switch and cutting off the second switch, and then will enter into a second timing cycle for conducting the first switch and conducting the second switch, so that the power storage element stores the power of the input voltage to generate the compensating current; and then the conversion module will enter into a third timing cycle for conducting the first switch and cutting off the second switch, and then will enter into a fourth timing cycle for cutting off the first switch and cutting off the second switch, so that the compensating current is outputted through the conversion element.

5. The power circuit with a low total harmonic distortion as claimed in claim 4, wherein the power storage element is an inductor, and the conversion element is a capacitor.
